(19) United States
(12) Patent Application Publication
(10) Pub. No.: US 2019/0263703 A1
(43) Pub. Date: Aug. 29, 2019

(54) HOLLOW CYLINDER OF CERAMIC MATERIAL, A METHOD FOR THE PRODUCTION THEREOF AND USE THEREOF

(71) Applicant: QSIL GMBH QUARZSCHMELZE ILMENAU, Langewiesen (DE)

(72) Inventors: Frank Peter Ludwig, Erfurt (DE); Lars Ortmann, Jena (DE); Janis Wehner, Erfurt (DE); Ralph Heubach, Ilmenau (DE)

(21) Appl. No.: 16/338,835

(22) PCT Filed: Oct. 4, 2017
(86) PCT No.: PCT/EP2017/075221

§ 371 Date: Apr. 2, 2019

(30) Foreign Application Priority Data
Oct. 5, 2016 (DE) 102016118826.3

(51) Int. Cl. C03B 19/09; B28B 21/30; B28B 21/80

(52) U.S. Cl. CPC C03B 19/095; B28B 1/20; B28B 21/80; B28B 21/30

(57) ABSTRACT

A method for producing a round tube from a ceramic material or a glass-ceramic material or mixtures thereof is described. The method comprises introducing a silicate-ceramic, oxide-ceramic and/or non-oxide-ceramic material-forming agent into a melting vessel, which has along a longitudinal axis a tubular wall which defines a tubular cavity, wherein the melting vessel rotates about its longitudinal axis. A uniform layer of the ceramic and/or glass-ceramic material-forming agents is thereby formed, lying on the inner side of the wall, by means of centrifugal forces generated by rotation and is heated by means of a heat source arranged in the inner cavity of the melting vessel until at least the inner side of the layer of material-forming agents has melted. Such tubes can be used for various industrial purposes.

The invention concerns a method for manufacturing a ceramic and/or glass-ceramic tube, which is gas-tight and corrosion-resistant in particular, a tube made using this method, and its use.

Corrosion-resistant and in particular also gas-tight tubes that are abrasion-resistant in addition are becoming more and more important for modern chemical processes. However, manufacturing them is extremely challenging. This applies in particular to the manufacture of tubes from high-sintering and high-melting materials, which requires raw materials and mixtures thereof to be fused or sintered in order to be processed into ceramics, glass-ceramics, or glass. These types of processes generally require temperatures of over 1900° C. Because very few stable materials exist for lining furnaces in this temperature range, these types of materials are generally melted with no crucible onto a wall that is itself made of a material pack. It is therefore common, in what is known as a skull-process, to fuse a material pack made of high-melting oxides through a combination of gas firing and superheating using high-frequency fields. As part of this process, the material pack is surrounded by a row of water-cooled pipes and cooled from the outside. On the outer surface cooled in that manner, a sinter layer builds up during the superheating process, which separates the molten material from the inner wall of the melting crucible or melting furnace and thereby protects the cooling pipes from overheating and contact with the molten material. This makes it possible to manufacture high-purity and high-melting materials into glass and glass-ceramics or ceramics. The resulting materials are, of course, in block form, from which the respective desired shape must be cut in a later processing step.

DE 10 2011 087 065 A1 discloses a method for manufacturing high-melting materials in a melting crucible using an electric arc. This type of melting crucible can be moved vertically to the electrons projecting into the furnace in order to control the melting rate, as described in DE 3633517 A1, for example. After the melting process is completed, the resulting molten material is cast or crystallized out into blocks or other geometric shapes.

U.S. Pat. No. 4,188,201 discloses a furnace structure for manufacturing silica glass, in which a quartz granulation held on the furnace wall by centrifugal force in a rotating furnace crucible fuses to a symmetrically rotating silica glass body as the result of heat supplied by gas firing and/or direct electric heating (graphite element). This involves significant temperature differences between the fired inner side of the pipe and the outer side, and the material is not destroyed only because silica glass has very low thermal expansion.

### Prior Art

EP 1 110 917 A2 discloses a method for manufacturing opaque quartz glass. In that patent, the opacity is generated by adding a volatile admixture to the material, which releases impurities and gases to produce an opaque glass. However, this type of product consists of an amorphous glass-type material, meaning that is solidified molten material. The volatile admixture used for this is in the ppm range and therefore cannot generate any exceptionally temperature-change-resistant fixed crystalline material.

U.S. Pat. No. 5,312,471 discloses a SiO₂ glass pipe with optically excellent characteristics. This material is manufactured by placing pure SiO₂ material in a rotating tube and melting it in an electric arc. Adding additional SiO₂ to the resulting interior space produces a vitreous tube formed from the outside in. This also yields a non-crystalline vitreous material. It is also known that pure SiO₂ glass, because of its amorphous structure and its very low expansion coefficient even at very high temperature gradients, produces only low voltage in the material and can relax during cooling due to visco-elastic flow of voltages appearing in the material across a wide temperature range over the glass transformation temperature Tg, which makes the material suitable for manufacturing with high locally occurring temperature gradients. The resulting material has only limited mechanical strength and very good temperature change resistance.

For all of the above-described processes, except for the manufacture of silica glass tubes, two separate facilities are generally necessary for manufacturing high-melting ceramic and glass-ceramic materials, i.e., one melting facility and one cooling facility. An additional disadvantage lies in the fact that, except for silica glass, these methods do not permit the manufacture of any rotation-symmetrical hollow cylinders without the use of an expensive mechanical processing stage.

It is generally known that, unlike the previously described methods for manufacturing amorphous materials such as standard glass, when manufacturing typical ceramics, due to their heat expansion characteristics, no high temperature differences should occur in the sinter body during the manufacturing process, especially during the cooling process, because otherwise they will be destroyed by the appearance of the electrical voltages. When manufacturing ceramics in the standard sintering process or in the melting-casting process, it generally occurs that the temperature differences in the sinter body or the cast body are clearly below 10 K, because higher temperature differences during cooling in the temperature range <800° C. can cause crack formation in the ceramic body, resulting in its destruction.

It is generally known that gas-tight Al₂O₃ pipes, for example, which are normally manufactured using the standard sintering technology, tolerate only moderate temperature differences and have only moderate temperature change resistance, so that the temperature gradient across the pipe wall cannot be above 120-150 K.

The invention's objective now is to surpass the previously described prior art and easily produce strong, manipulable ceramic or glass-ceramic materials, in particular pipes, especially for the technical uses and processes mentioned in the description.

Another objective of the invention is to produce pipes that are gas-tight and in particular have high corrosion resistance and are also abrasion-resistant. A further objective of the invention is to manufacture this type of pipe in a single process step, in which the pipe can be taken directly from the melting furnace. Another objective of the invention is to manufacture this type of pipe at a reasonable cost.

The objectives described above are achieved through the measures and features defined in the claims.

Specifically, according to the invention it was found that these objectives can be achieved by introducing a ceramic- or glass-ceramic-producing material or mixtures thereof into a tube-shaped melting crucible. Such a melting crucible has a horizontal tube axis, around which the melting crucible rotates. The selected rotation speed is such that the generated centrifugal forces distribute the introduced ceramic- or glass-ceramic-producing raw material uniformly on the inner wall of the rotating melting crucible. There is normally no upper limit to the rotation speed. It depends primarily on the stability and strength of the overall melting apparatus. In practical application, however, highest rotation speeds of 2000 and in particular 1800 revolutions per minute have proven appropriate, with highest speeds of 1600, or in particular 1500, proving to be practical. Highest rotation speeds of 1450 and 1400 rpm have proven especially useful. Normal minimum rotation speeds are 80 or in particular 100 rpm, with at least 150 rpm and especially at least 200 rpm preferred. Even more preferred are minimum rotation speeds of 250 or 300 rpm.

It was then surprisingly found that, using the type of process in which tubes are heated only from one side, preferably from the inside, with a high temperature gradient, a ceramic pipe can be produced under rotation that is strong in spite of this high temperature difference between the inner and outer walls, not only during manufacturing but also even after it is cooled.

The powdered or granulated materials introduced according to the invention have a grain size such that they can be fed easily into the apparatus and under rotation are deposited uniformly on the inner wall of the rotating tube furnace to a uniform wall thickness over the entire length of the furnace crucible.

The material introduced in this manner is then melted by a heat source located inside the hollow space in the melting crucible created by the rotation. The melting process lasts until at least the inner side of the ceramic material is melted, but not the side facing the wall of the melting crucible. In this way it is possible to manufacture a ceramic, glass-ceramic, or high-melting glass tube without the tube coming into contact with the melting crucible itself and thereby introducing impurities into the tube product. The tube has, in particular, a rotation-symmetrical cross-section.

The method according to the invention is especially well suited for powdered or granular materials having electrically insulating properties especially in packs and as solid bodies, and/or showing no sublimation or gas release during temperature manipulation or superheating. These properties are especially advantageous when an electric arc is used as the heat source. The materials introduced in the method according to the invention preferably have a high melting point. Typical melting temperatures for the method according to the invention are above 1350° C., in particular above 1400° C., with minimum temperatures of >1400° C. or 1500° C. preferred. Melting temperatures >1600° C. and in particular >1700° C. are especially preferred. Typical maximum melting temperatures are up to 3300° C., with up to 3000° C. and in particular 2300° C. preferred.

Heat can be provided by any internally located heat source, such as resistance heating or even hot gases, and heat generated by an electric arc has proven especially practical.

Ceramic or glass-ceramic materials typically used in the method according to the invention include in particular oxides, nitrides, carbides, silicates, titanates, silicate-ceramic, oxidic and non-oxidic ceramic base materials, as well as high-melting glass raw materials if appropriate, in particular Al₂O₃, ZrO₂, ZrSiO₄, BaO, SiC, SiN, BN, BeO, TiO₂, CaO, SiO₂, MgO and their mixtures, barium titanate and/or aluminum titanate. Also exceptionally well-suited materials are AZS materials from the ternary system. Al₂O₃—ZrO₂—SiO₂.

The AZS materials preferred according to the invention normally have a composition containing 5-28 wt. % SiO₂, 34.5-72 wt. % Al₂O₃, and a ZrO₂ content that is greater than 0 and in particular 5-50.7 wt. %. The components SiO₂, ZrO₂, and Al₂O₃ together with any other appropriately included impurities amount to a total of 100 wt. %. An especially preferred embodiment according to the invention contains 14.3 wt. %±5 wt. % SiO₂, 35.3%±5 wt. % ZrO₂, and 48.6 wt. %±5 wt. % Al₂O₃. The composition preferably is no more than 2 wt. % and in particular 1 wt. % from the amounts stated above. All of the % values mentioned above are based on weight.

Heat is normally introduced into an atmosphere consisting primarily of inert gases. Typical gases are argon, helium, nitrogen, as well as hydrogen if necessary in an amount that does not reduce efficacy.

When electric arc superheating is performed, the electric arc is normally ignited by combining two ignition lances in the interior hollow space in the melting crucible.

In the melting and sintering process, it is important that the heat supply be constant over the entire length of the tube being manufactured, or if an electric arc is being used, that it burn over the entire length of the hollow space. The temperature is governed by the output of the heat source. According to the invention, it has been shown that the tube is being melted and sintered adequately once the heat flow moving from the melting crucible outward is more or less constant. This is determined in practical application by heat sensors located in the outer area. Especially well suited for this is measuring water temperatures in water-cooled elements placed around the melting crucible as appropriate.

In one practical embodiment, the ceramic or ceramic-producing material is introduced into the tube-shaped melting crucible in powder or granular form. Typical grain sizes for the material are at least 0.5 μm or 1 μm, and minimum sizes of 2 μm or in particular 4 μm are preferred. Minimum sizes of 5 μm or 10 m are especially preferred. In practical application, maximum grain sizes here are up to 2 mm, and up to 1 mm or 0.8 mm, and especially 0.5 mm, are preferred.

At the end of the process, the partly melted, partly sintered material in the melting crucible is cooled, and after cooling it is easily removed from the tube-shaped crucible, because during the melting/sintering process the outer powder or granular material is still not sintered. After removal, the rough adhered outer raw material is ground smooth and can be reused as needed. This makes it possible to execute the method according to the invention in a single process step and to do it more or less without material loss.

The invention also concerns a tube produced with the method. Such a tube has a combination of an inner material layer that is fully solidified after melting and a sintered outer layer.

In one particular embodiment, the inner layer formed from melted material is more or less pore-free, meaning that it has high density, very near the theoretical density of the material. This makes the tube especially gas-tight when it is used with respect to the materials on its inner surface. On the other hand, the outer wall of the tube consists of a more-or-less porous ceramic material with a significantly lower density than the inner wall. Typical densities for the materials on the inside are at least 99% of the theoretical density of the compacted material, with at least 99.2% or 99.4% preferred. Especially preferred are theoretical densities of at least 99.5%, in particular 99.8%.

Even more preferred are theoretical densities of at least 99.9%, in particular 99.99%. The theoretical densities on the outer wall are typically at most 95% of the theoretical density of the material, with at most 93% and in particular 90% preferred. The minimum density varies over a wide range and depends essentially upon the grain size and sintering behavior of the material. Typical minimum densities are 80%, in particular 82%, and at least 85% has proven to be practical. Between the inner and outer walls, the density varies in stages or in gradient form.

Preferred tubes have a temperature change resistance >150 K, in particular >155 K, and >160 K or in particular >170 K is common. In many cases, however, the temperature change resistance is >200 K, in particular >250 K. Even with double-shock quenchings at >750 K, the material according to the invention exhibits only very low strength reduction, <10% of output strength at room temperature, and practically no optically detectable crack formation in the material, making it suitable for use with hot corrosive gases, glass melts, and metals.

It is known that ceramic materials normally have a nearly completely, or at least predominantly, crystalline structure. The material produced by the method according to the invention therefore also consists of at least 65 wt. % crystalline material, but normally at least 70 wt. % and preferably 75 or 80 wt. %. Especially preferred are materials consisting of more than 85 or 90 wt. % crystal, with at least 93 or 95% crystalline material even more preferred. The remaining portion is normally amorphous and can also be of a glass type, i.e., consisting of a non-crystalline solidified melt.

Tubes according to the invention have crystallites in the inner high-density area with a maxim size of less than 10 mm, in particular between 5000 μm and 200 μm, and 2000 μm or 200 μm is common. In the low-density area on the outside, the tube according to the invention typically has crystallite sizes that depend on the material grain used and on the sintering conditions in the manufacturing process (temperature, pressure, and time) and preferably lie in the range between 100 μm and <1 μm.

Tubes according to the invention have a diameter that is limited only by the dimensions of the melting crucible. Typical melting crucibles currently have a diameter of up to 1000 mm, in particular up to 900 mm, and generally 800 mm in practice. Minimum diameters are currently at least 10 mm, with at least 20 mm and in particular at least 50 mm preferred. Practical diameters are in particular 60 mm or 70 mm, with 80 mm most preferred.

In one preferred embodiment, tubes according to the invention have high temperature change resistance.

Tubes according to the invention or tubes made with the method according to the invention are especially well suited to use as rotating tube furnaces for annealing objects in the range of >1000° C., in particular >1100° C., and with temperatures of even up to 1700° C. also possible. A typical material is cement, for example. In this type of use, materials can simply be fed through the tube in the furnace.

Another use of the tubes according to the invention is in waste incineration. For this type of use, it is important to be able to burn not only at appropriately high temperatures but also in the presence of highly oxidative gases such as gases containing halogen, for example, in a corresponding atmosphere. Another use lies in conducting flue gases, which contain soot in particular and also other mineral particles that are highly abrasive.

Tubes according to the invention are also well suited for use in manufacturing glass, and as both the feeder pipe and, if applicable, the outlet pipe and/or as round-shaped glass channels.

The invention is explained in more detail in the following examples.

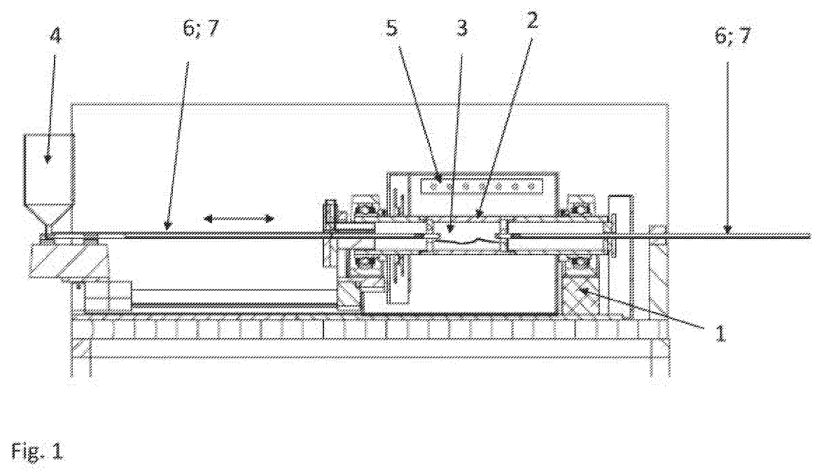

FIG. 1 shows one arrangement for executing the method for producing tubes according to the invention. Here a furnace-shaped melting crucible (2) is located in a turning machine (1) so that it rotates. The ceramic-producing material is introduced into the hollow space inside the melting crucible (2) using filling equipment (4) and a filling lance (6) and is distributed uniformly over the inner wall of the melting crucible (2) by means of rotation, as shown schematically (3). After a heat source is switched on (ignition of an electric arc in this case), the material adhering to the wall due to centrifugal force is fused from the inside out. The fusing process is complete when the heat flow passing through the cooling water reaches a stationary value and no longer changes. Because at that point a status is achieved in which the inside of the tube is completely fused, the part following it is baked solid through a ceramic sintering process, and the part located outside on the wall of the melting crucible is still granular, the finished tube can be removed after cooling with no further processing required.

The ignition lances (7) are equipped with graphite electrodes on the lance tips that are pulled apart from each other after the electric arc is ignited and then form the electrodes on the furnace crucible ends between which the electric arc operates. The filling lance (6) is an ignition lance (7) with no graphite electrode on the tip. Here there is a defined opening for it, through which the raw material powder is distributed evenly over the length of the furnace space. The filling lance (6) is moved in the furnace crucible in the same manner and form as the ignition lances (7) and is replaced by the ignition lances (7) for the purpose of ignition.

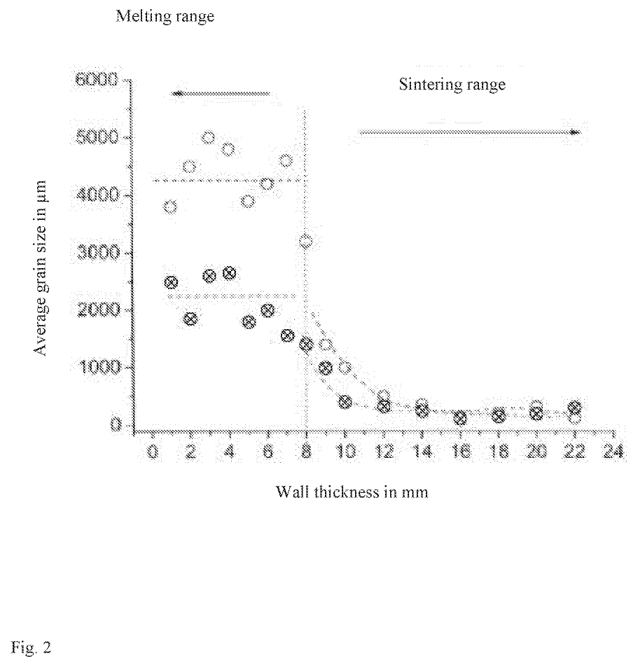

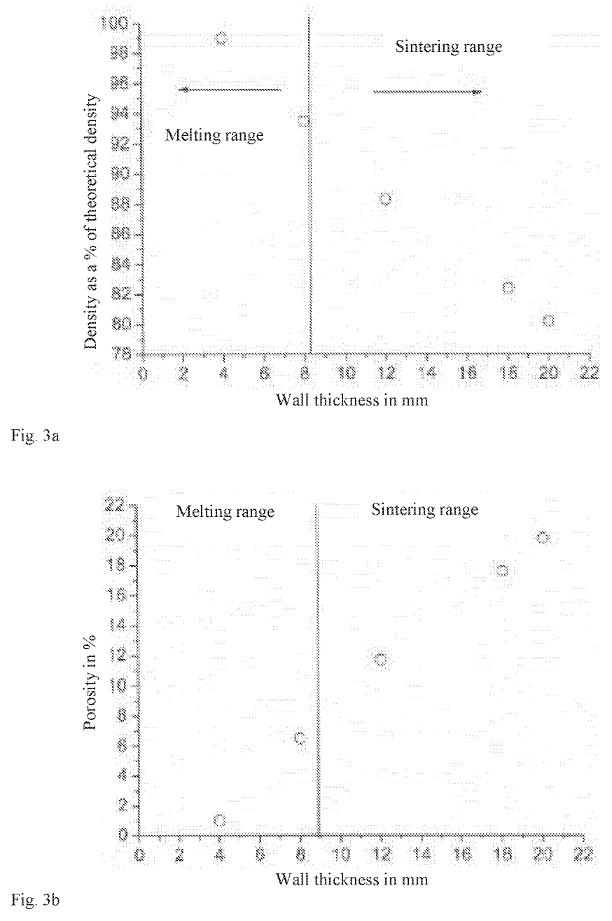

FIG. 2 shows a typical spread of the crystalline grain size distribution on the finished tube as a function of wall thickness. It shows that the crystal grain size increases from the inside outward and then drops significantly back down in the sintering area. The relationship between density and porosity of the tube wall is shown in FIGS. 3a and 3b. In them, a high density in the melting area shows low porosity and a low density in the sintering area shows high porosity. Because of the high density and low porosity, the insides of tubes according to the invention exhibit high gas-tightness.

### LIST OF REFERENCE INDICATORS

1 Glass rotating machine
2 Furnace crucible
3 Material packing in the furnace crucible
4 Filling equipment
5 Cooling water equipment
6 Movable filling lances
7 Movable ignition lances with electrodes

1.-11. (canceled)

12. A method for manufacturing a hollow cylinder from a ceramic material or a glass-ceramic material or mixtures thereof, comprising:
introducing at least one of a silicate-ceramic, oxide-ceramic, and non-oxide-ceramic base material having a grain size of 0.5 μm to 2 mm into a melting crucible which has a tube-shaped wall that defines a tube-shaped hollow space;
rotating the melting crucible around its central longitudinal axis, to cause a uniform layer of the base material to form on the tube-shaped wall due to rotation-generated centrifugal forces, the uniform layer forming a hollow cylinder having an interior face and an exterior face, the exterior face being adjacent the tube-shaped wall of the crucible, and the interior face defining an interior hollow space;
superheating the base material by a heat source located an the interior hollow space, until at least the interior face of the hollow cylinder is fused, but the exterior face is not fused; and
cooling the fused interior face of the hollow cylinder at a cooling rate greater than 5 K/min.

13. The method of claim 12 wherein the base material is selected from the group of ceramic materials consisting of Al₂O₃, ZrO₂, ZrSiO₄, BaO, SiC, SiN, BN, BeO, TiO₂, barium titanate, aluminum titanate, MgO, SiO₂, CaO, and mixtures thereof.

14. The method of claim 12 wherein the base material is selected from the group of ceramic materials consisting of AZS materials from the ternary system Al₂O₃—ZrO₂—SiO₂.

15. The method of claim 12 wherein the base material has a grain size of 1 μm to 1 mm.

16. The method of claim 12 wherein the base material is comprised of 5-28 wt. % SiO₂, 34.5-72 wt. % Al₂O₃, and 5-50.7 wt. % ZrO₂.

17. The method of claim 12 wherein the heat source is a resistance heater or an electric arc located in the interior hollow space of the hollow cylinder.

18. A hollow cylinder made by introducing at least one of a silicate-ceramic, oxide-ceramic, and non-oxide-ceramic base material having a grain size of 0.5 μm to 2 mm into a melting crucible which has a tube-shaped wall that defines a tube-shaped hollow space;
rotating the melting crucible around its central longitudinal axis, to cause a uniform layer of the base material to form on the tube-shaped wall due to rotation-generated centrifugal forces, the uniform layer forming a hollow cylinder having an interior face and an exterior face, the exterior face being adjacent the tube-shaped wall of the crucible, and the interior face defining an interior hollow space;
superheating the base material by a heat source located in the interior hollow space, until at least the interior face of the hollow cylinder is fused, but the exterior face is not fused; and
cooling the fused interior face of the hollow cylinder at a cooling rate greater than 5 K/min.

19. A hollow cylinder having an interior face and an exterior face, the interior face defining an interior hollow space, the hollow cylinder comprised of at least one of a silicate-ceramic, oxide-ceramic, and non-oxide-ceramic base material having a grain size of 0.5 μm to 2 mm, the interior face of the hollow cylinder being fused, but the exterior face is not fused.

20. The hollow cylinder of claim 19, wherein the base material is selected from the group of ceramic materials consisting of Al₂O₃, ZrO₂, ZrSiO₄, BaO, SiC, SiN, BN, BeO, TiO₂, barium titanate, aluminum titanate, MgO, SiO₂, CaO, and mixtures thereof.

21. The hollow cylinder of claim 19 wherein the base material is selected from the group of ceramic materials consisting of AZS materials from the ternary system Al₂0₃—ZrO₂—SiO₂.

22. The hollow cylinder of claim 19 wherein the base material has a grain size of 1 μm to 1 mm.

23. The hollow cylinder of claim 19 wherein the base material is comprised of 5-28 wt. % SiO₂, 34.5-72 wt. % Al₂O₃, and 5-50.7 wt. % ZrO₂.

24. The hollow cylinder of claim 19 wherein the interior face and the exterior face of the hollow cylinder define a wall thickness, the wall thickness having a density that is at least 99% of a theoretical density of compact material on the interior face and at most 95% of the theoretical density on the exterior face, and wherein density from the interior face to the exterior face changes in stages or as a gradient.

25. The hollow cylinder of claim 19 wherein the hollow cylinder contains one of corrosion aggressive gasses at temperatures above 1100° C., cement, melted glass, molten metal pyrolyzing materials at a temperature above 1450° C., oxidizing atmosphere, halogen-containing atmosphere and flue gases.

26. The hollow cylinder of claim 19, also comprising a glass manufacturing apparatus the hollow cylinder serving as at least one of a feeder element and an outflow pipe in the glass manufacturing apparatus.

27. The hollow cylinder of claim 19 also comprising a glass furnace in which the hollow cylinder is a component.

28. The hollow cylinder of claim 19 also comprising a rotary furnace in which the hollow cylinder is a component.
